(19) United States
(12) Patent Application Publication
(10) Pub. No.: US 2026/0008218 A1
(43) Pub. Date: Jan. 8, 2026

(54) SETTING SUPPORT SYSTEM, INJECTION MOLDING MACHINE, AND PROGRAM

(71) Applicant: SUMITOMO HEAVY INDUSTRIES, LTD., Tokyo (JP)

(72) Inventor: Xiangyu CHU, Chiba-shi (JP)

(21) Appl. No.: 19/185,305

(22) Filed: Apr. 22, 2025

(30) Foreign Application Priority Data
Jul. 4, 2024 (JP) 2024-108273

(51) Int. Cl. B29C 45/76; G06F 3/0482; G06F 3/04847

(52) U.S. Cl. CPC B29C 45/766; B29C 45/7653; B29C 2045/7606; B29C 2945/76505; B29C 2945/76702; B29C 2945/76869; B29C 2945/76946; G06F 3/0482; G06F 3/04847

(57) ABSTRACT

A setting support system includes: a first reception unit that receives, regarding a setting of sequence control that controls a series of operations in a machine, inputs of component information indicating an operation component that operates in the series of operations and operation order information indicating an operation order of the operation component; a processing unit that specifies a time range in which each of a plurality of target operations constituting the series of operations is executable based on the component information and the operation order information and a logic of a sequence for the series of operations; and a display control unit that displays, on a display device, a sequence image in which a plurality of target images corresponding to each of the plurality of target operations are disposed in an execution order, based on the time range specified for each of the plurality of target operations.

### CROSS-REFERENCE TO RELATED APPLICATIONS

This application claims priority to Japanese Patent Application No. 2024-108273, filed on Jul. 4, 2024, which is incorporated by reference herein in its entirety.

### BACKGROUND

### Technical Field

A certain embodiment of the present invention relates to a setting support system, an injection molding machine, and a program.

### Description of Related Art

The related art discloses a display device used for operating an injection molding machine, the display device including a display unit that displays a plurality of operation objects representing each operation performed in a molding process, an input unit through which an operator inputs a selection and a disposition of the operation objects, and a control unit that determines the operation objects disposed by the operator, in which the control unit gives the operator a suggestion to assist in constructing an array of the operation objects based on at least one of information regarding a relationship with the already disposed operation objects and information regarding a mold unit input in advance.

### SUMMARY

According to an embodiment of the present invention, there is provided a setting support system including: a first reception unit that receives, regarding a setting of sequence control that controls a series of operations in a machine, inputs of component information indicating an operation component that is a component that operates in the series of operations and operation order information indicating an operation order of the operation component; a processing unit that specifies a time range in which each of a plurality of target operations that constitute the series of operations is executable based on the component information and the operation order information and a logic of a sequence for the series of operations; and a display control unit that displays, on a display device, a sequence image, which is an image in which a plurality of target images corresponding to each of the plurality of target operations are disposed in an execution order, based on the time range specified for each of the plurality of target operations.

### BRIEF DESCRIPTION OF THE DRAWINGS

FIG. 1 is a diagram illustrating a configuration of an injection molding machine to which the present embodiment is applied.

FIG. 2 is a diagram illustrating a configuration of a control device.

FIG. 3 is a diagram illustrating a configuration of a data processing device.

FIG. 4 is a diagram illustrating a configuration of a setting support device.

FIG. 5 is a diagram illustrating an example of a hardware configuration of a computer that implements the control device, the data processing device, and the setting support device.

FIG. 6 is a diagram illustrating a configuration example of a UI screen generated by a screen generation unit of the setting support device.

FIGS. 7A to 7D are diagrams illustrating examples of methods for inputting component information and operation order information, where FIG. 7A is a diagram illustrating a method for inputting component information, FIG. 7B is a diagram illustrating a method for inputting in a first condition selection unit, FIG. 7C is a diagram illustrating a method for inputting one condition item in a second condition selection unit, and FIG. 7D is a diagram illustrating a method for inputting another condition item in the second condition selection unit.

FIG. 8 is a diagram illustrating a state in which a target image is disposed on a sequence image in a sequence image display unit on the UI screen illustrated in FIG. 6.

### DETAILED DESCRIPTION

In a system in which sequence control is performed on the operation of a plurality of drive components, such as an injection molding machine or the like, it may be necessary to change an operation order or an operation amount of machines or components that constitute the system depending on the specifications, operating conditions, or the like of the machines or the components. On the other hand, when an operator is allowed to freely set the operation order or the operation amount of machines or components, there is a concern that due to inappropriate settings, the system may not operate normally or the machines or the components that constitute the system may be damaged.

It is desirable to prevent an operator from making inappropriate settings when the operator changes settings of an operation order or an operation amount of a machine or a component in sequence control.

Hereinafter, an embodiment of the present invention will be described in detail with reference to the accompanying drawings.

### Device Configuration

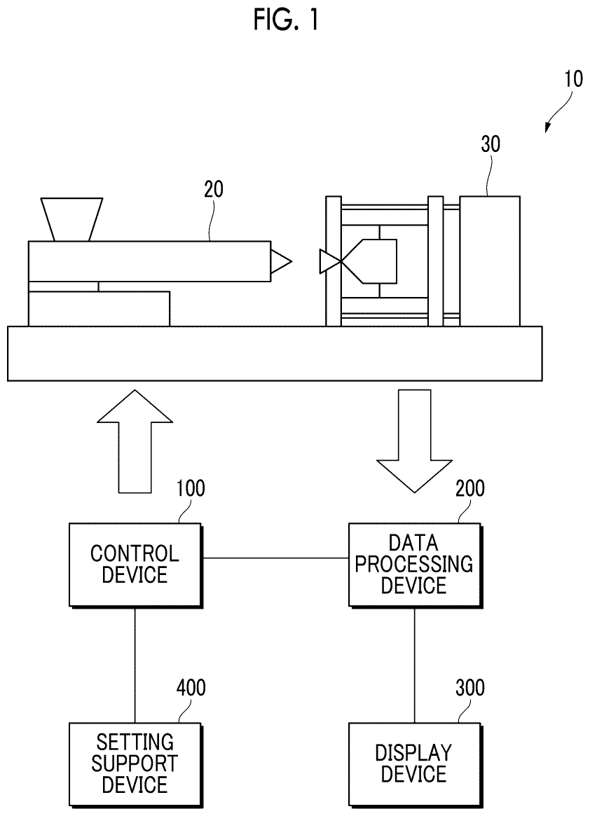

FIG. 1 is a diagram illustrating a configuration of an injection molding machine to which the present embodiment is applied. An injection molding machine 10 includes an injection unit 20, a mold clamping unit 30, a control device 100, a data processing device 200, a display device 300, a setting support device 400. In the following description, a direction from the injection unit 20 toward the mold clamping unit 30 may be referred to as forward.

The injection unit 20 includes a cylinder that heats a molding material, a screw that is rotatable in the cylinder and that is provided to be able to advance and retreat in an axial direction, a rotary motor that drives the screw in a rotational direction, a motor that drives the screw in the axial direction, and the like. The molding material is, for example, a resin or the like. The injection unit 20 injects the molding material heated and liquefied within the cylinder by advancing the screw forward while rotating the screw, and fills a mold of the mold clamping unit 30 disposed in front of the injection unit 20 with the molding material. The injection unit 20 performs, for example, a plasticizing process, a filling process, a holding pressure process, and the like in a manufacturing process of a molding product. The filling process and the holding pressure process may be collectively referred to as an injection process.

The mold clamping unit 30 includes a mold, a tightening mechanism for tightening the mold, a motor for driving the tightening mechanism, and the like. The mold clamping unit 30 closes the mold and receives the molding material injected from the injection unit 20 into the inside of the mold. In this case, the mold clamping unit 30 tightens the mold with the tightening mechanism such that the mold does not open because of the filling of the molding material (mold clamping). A molding product is produced by solidifying the molding material filled in the mold. After that, the mold clamping unit 30 opens the mold and feeds out the produced molding product. The mold clamping unit 30 performs, for example, a mold closing process, a pressurizing process, a mold clamping process, a depressurizing process, a mold opening process, and the like in a manufacturing process of a molding product.

The control device 100 is a device that controls the operations of the injection unit 20 and the mold clamping unit 30. The data processing device 200 is a device that processes data obtained as the injection unit 20 and the mold clamping unit 30 operate. The display device 300 displays information related to the control of the injection unit 20 and the mold clamping unit 30 by the control device 100, data acquired by the data processing device 200, a processing result of the data processing device 200, and the like. In addition, the display device 300 displays an operation screen for performing an operation of inputting commands or data to the control device 100 or the data processing device 200. The setting support device 400 is a device that supports the generation of setting information for the control device 100 to control the operations of the injection unit 20 and the mold clamping unit 30.

### Configuration of Control Device 100

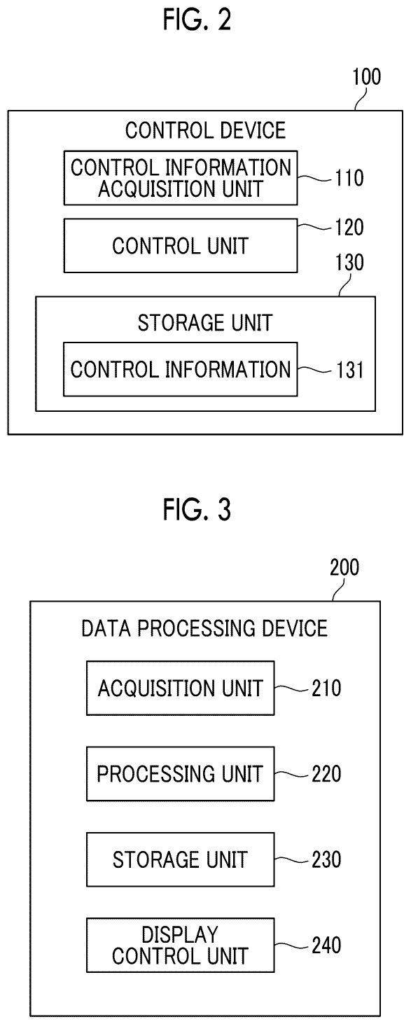

FIG. 2 is a diagram illustrating a configuration of the control device 100. The control device 100 controls the operations of the injection unit 20 and the mold clamping unit 30. For example, the control device 100 is implemented by a computer. The control device 100 includes a control information acquisition unit 110, a control unit 120, and a storage unit 130. The control device 100 controls the injection unit 20 and the mold clamping unit 30 to repeatedly perform processes related to the manufacture of a molding product, thereby repeatedly manufacturing the molding product. Processes related to the manufacture of a molding product include a plasticizing process, a mold closing process, a pressurizing process, a mold clamping process, a filling process, a holding pressure process, a cooling process, a depressurizing process, a mold opening process, an ejecting process, and the like. Hereinafter, these processes related to the manufacture may be collectively referred to as a “manufacturing process”. A series of operations for obtaining the molding product, for example, an operation from the start of the plasticizing process in the manufacturing process to the start of the next plasticizing process is referred to as a “shot”, a “molding cycle”, or the like. Further, each of the above-described processes for manufacturing a molding product is merely an example. For example, the process executed in one shot may include other processes not included in the above processes.

The control information acquisition unit 110 acquires control information used to control the injection unit 20 and the mold clamping unit 30. The control information is a condition set by a user, and is input by the user using, for example, an input device (not illustrated). The control information includes, for example, molding conditions such as a resin temperature, a mold temperature (cylinder temperature), an injection holding pressure time, a plasticizing value, a V-P switching position, a holding pressure, an injection speed (filling speed), a screw rotation speed, a screw back pressure, and a mold clamping force. A plurality of combinations of these molding conditions are determined according to the molding product and the mold. This combination data of the molding conditions will be hereinafter referred to as a molding condition data set. The control information acquisition unit 110 stores the acquired control information in the storage unit 130 as a molding condition data set.

The control unit 120 controls the injection unit 20 and the mold clamping unit 30 using the above-described molding condition data set, and performs processes related to the manufacture (shot) of a molding product including each of the above-described processes. The control unit 120 reads the molding condition data set corresponding to the molding product to be manufactured from the storage unit 130 at the time of starting the manufacturing of the molding product or the like. Then, the control unit 120 controls the operations of the injection unit 20 and the mold clamping unit 30 based on the read control information. Specifically, the control unit 120 controls the injection unit 20 and the mold clamping unit 30 such that the data obtained from the injection unit 20 and the mold clamping unit 30 in the manufacturing process match setting values of the molding condition data set. In addition, the control unit 120 may cause the display device 300 to display the molding condition data set read from the storage unit 130. The user may refer to the data of the molding condition displayed on the display device 300 and perform an operation such as correction of the value as necessary.

The storage unit 130 holds control information 131 acquired by the control information acquisition unit 110. The molding condition data set included in the control information 131 is prepared in association with the molding product or the mold to be manufactured. The storage unit 130 holds a molding condition data set for each molding product or mold to be manufactured. Further, although not illustrated, the storage unit 130 holds a program for the control unit 120 to control the injection unit 20 and the mold clamping unit 30. As will be described in detail later, the function of the control unit 120 is implemented by a processor that reads and executes a program held in the storage unit 130 in the control device 100.

### Configuration of Data Processing Device 200

FIG. 3 is a diagram illustrating a configuration of the data processing device 200. The data processing device 200 acquires and processes data obtained as the injection unit 20 and the mold clamping unit 30 execute the operations in the process related to the manufacture of the molding product. The data processing device 200 is implemented by, for example, a computer. The data processing device 200 includes an acquisition unit 210, a processing unit 220, a storage unit 230, and a display control unit 240.

The acquisition unit 210 acquires data to be processed from the injection unit 20 and the mold clamping unit 30. Various sensors and detectors are attached to the injection unit 20 and the mold clamping unit 30. The data acquired by these sensors and detectors (hereinafter referred to as “acquired data”) is information indicating a molding result by the injection unit 20 and the mold clamping unit 30, and is used for quality control of a molding product. Specifically, for example, a weight of the molding product, dimensions of the molding product, a mold internal pressure, a minimum cushion position, a characteristic amount of a waveform of a filling pressure, and the like are included. These pieces of acquired data are actual values obtained in the manufacturing process of the molding product. The acquisition unit 210 receives acquired data transmitted from the sensors or the detectors, and stores the acquired data in the storage unit 230.

The processing unit 220 processes the acquired data stored in the storage unit 230. Specifically, the processing unit 220 performs a process of extracting a representative value of the acquired data in each process and generating time-series data in which the acquired data in each process is time-series. In the extraction of the representative value, the processing unit 220 performs statistical processing on the acquired data, such as calculation of an average value, specification of a range within which the value is taken, and specification of a maximum value and a minimum value.

The storage unit 230 holds representative values, time-series data, statistical data, and the like processed by the processing unit 220. These pieces of data are associated with, for example, the original acquired data. Specifically, these pieces of data may be stored in the data file of the corresponding original acquired data. In addition, a data file storing these pieces of data may be associated with the data file of the original data. Accordingly, each piece of data generated by the processing unit 220 is also held in association with the molding product or the mold to be manufactured in the shot from which the original acquired data was obtained. For example, comma separated values (CSV), Extensible Markup Language (XML), JavaScript Object Notation (JSON), or the like can be used as the data format of the data file held in the storage unit 230.

Although not illustrated, the storage unit 230 holds a program for the processing unit 220 to execute data processing. As will be described in detail later, the function of the processing unit 220 is implemented by the processor that reads and executes a program held in the storage unit 230 in the data processing device 200.

The display control unit 240 causes the display device 300 to display the acquired data and the data of the processing result obtained by the processing unit 220. The data to be displayed includes setting information in the control information used by the control device 100 to control the injection unit 20 and the mold clamping unit 30. The setting information (setting values) can be acquired from the control device 100. The display control unit 240 acquires these pieces of data from the storage unit 230 or the storage unit 130 of the control device 100, and causes the display device 300 to display them.

### Configuration of Setting Support Device 400

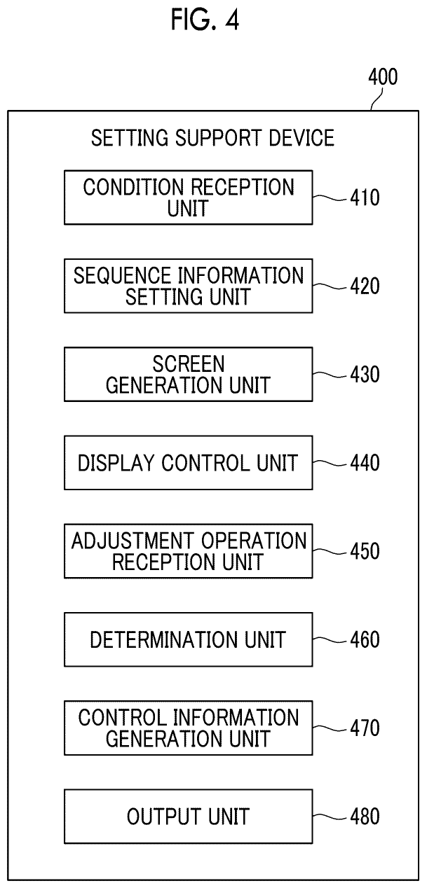

FIG. 4 is a diagram illustrating the configuration of the setting support device 400. The setting support device 400 receives operations by a user and generates setting information for the control device 100 to control the operations of the injection unit 20 and the mold clamping unit 30. For example, the setting support device 400 is implemented by a computer. The setting support device 400 includes a condition reception unit 410, a sequence information setting unit 420, a screen generation unit 430, a display control unit 440, an adjustment operation reception unit 450, a determination unit 460, a control information generation unit 470, and an output unit 480.

As described above, the control device 100 controls a series of operations performed by the injection unit 20 and the mold clamping unit 30 (hereinafter, control of this series of operations will be referred to as “sequence control”). In sequence control, the execution timing and operation content of each operation in a series of operations performed by the injection unit 20 and the mold clamping unit 30 are set. Depending on various conditions such as the specifications of the injection molding machine and the type of molding product, it may be necessary to change the settings for each operation that is the target of sequence control (hereinafter referred to as a “target operation”). The setting support device 400 supports the setting by the user for the target operations of this sequence control.

The condition reception unit 410 receives input operations by the user for setting a series of operations that are the target of sequence control. Specifically, the condition reception unit 410 receives, as setting conditions, for example, inputs of component information indicating the components (hereinafter referred to as “operation components”) that operate in the series of operations to be set, and operation order information indicating the operation order of the operation components. The component information also includes information on the number of components. Furthermore, the condition reception unit 410 may receive an input of more detailed execution conditions related to the operation of the operation component. The condition reception unit 410 is an example of a first reception unit. The method of receiving an input by the condition reception unit 410 and the details of the input content will be described later.

The sequence information setting unit 420 generates sequence information based on the information received by the condition reception unit 410. The sequence information is information for specifying an execution order of each target operation and a time range in which each target operation is executable in a series of operations that are the target of sequence control. The time range in which each target operation is executable is determined so that a logic of the sequence in the series of operations that are the target of sequence control is established. The expression “a logic of the sequence is established” means that the execution of a plurality of target operations does not conflict in the logic. For example, the execution of a plurality of contradictory target operations in parallel, or the execution of a second target operation that is a prerequisite for a first target operation after the first target operation, is avoided because the logic of the sequence is not established. Information and rules regarding the logic of the sequence are held by, for example, a storage device (not illustrated) of the setting support device 400. The sequence information setting unit 420 is an example of a processing unit.

The screen generation unit 430 generates a sequence image based on the sequence information generated by the sequence information setting unit 420. A sequence image is an image in which a plurality of target images corresponding to each of the target operations, the time range of which is defined by the sequence information, are disposed in the execution order of the target operations. The disposition position of the target image is set, for example, at a position specified by a predetermined criterion within a range on the sequence image corresponding to the time range defined in the sequence information. This disposition position may be predetermined depending on the type of target operation, the combination of operation components that operate in the target operation, or the like, or may be the median value in a range on the sequence image corresponding to the time range. Moreover, the screen generation unit 430 generates a user interface screen (UI screen) that includes this sequence image and presents information to the user and receives a user's operation. The sequence image and the UI screen will be described in detail later.

The display control unit 440 displays the UI screen generated by the screen generation unit 430 on the display device of the setting support device 400. The UI screen is used for operations by the user. Therefore, the display control unit 440 reflects the operation performed by the user on the UI screen on the screen. For example, when an operation of instructing display of a menu is performed, the display control unit 440 displays the instructed menu on the display device. Furthermore, when an operation is performed on the sequence image, the display control unit 440 updates the display content of the sequence image in response to the operation. The screen generation unit 430 and the display control unit 440 are examples of a display control unit.

The adjustment operation reception unit 450 receives a user's operation on the sequence image generated by the screen generation unit 430 and displayed on the display device by the display control unit 440. The operation on the sequence image is, for example, an operation of moving each of the target images on the sequence image. When the position of a target image is adjusted by an operation on a sequence image, the execution timing of a target operation, among the target operations in the sequence information, that corresponds to the adjusted target image is adjusted. The adjustment operation reception unit 450 is an example of a second reception unit.

A limit may be set for the movement range of the target image on the sequence image received by the adjustment operation reception unit 450. For example, the movable range of each target image in the sequence image may be limited to a range corresponding to the time range of each target operation corresponding to each target image in the sequence image, as specified in the sequence information.

The determination unit 460 determines whether or not, in the disposition of the target image on the sequence image adjusted by the operation received by the adjustment operation reception unit 450, the logic of the sequence is established for the target operation corresponding to the target image. A change in the disposition of a target image on a sequence image means that the execution timing of a target operation corresponding to the target image has been changed. Therefore, the determination unit 460 determines whether or not this change in execution timing is within a time range in which the target operation that is permitted in the logic of the sequence is executable. The determination unit 460 is an example of a determination unit. As described above, when a limit is set on the movement range of a target image on a sequence image, the execution timing of the target operation corresponding to each adjusted target image is included in the time range in which the target operation is executable according to the logic of the sequence. Therefore, in this case, the determination unit 460 does not need to make a determination.

The control information generation unit 470 generates control information for executing a plurality of target operations constituting a series of operations in the injection unit 20 and the mold clamping unit 30 at the execution timing set by the sequence information. The generated control information is used by the control device 100 to control the operations of the injection unit 20 and the mold clamping unit 30. The control information generation unit 470 is an example of a control information generation unit. The output unit 480 transmits the control information generated by the control information generation unit 470 to the control device 100.

Hardware Configuration of Computer that Implements Control Device 100, Data Processing Device 200, and Setting Support Device 400

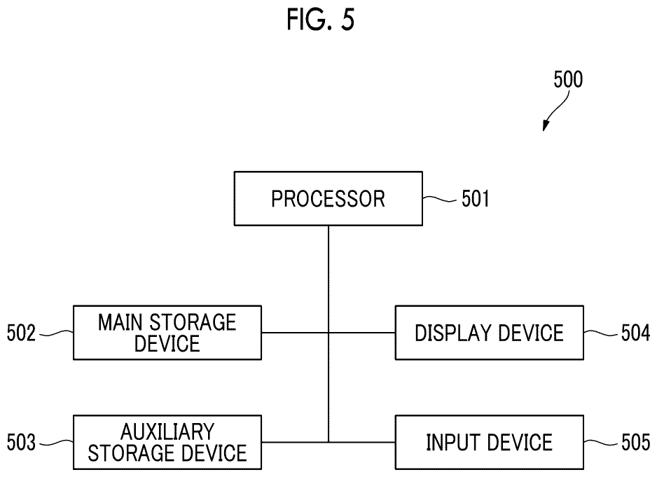

FIG. 5 is a diagram illustrating an example of a hardware configuration of a computer 500 that implements the control device 100, the data processing device 200, and the setting support device 400. The computer 500 illustrated in FIG. 5 includes a processor 501 as calculation means, and a main storage device (main memory) 502 and an auxiliary storage device 503 as storage means. As the processor 501, for example, various arithmetic circuits such as a central processing unit (CPU), a graphics processing unit (GPU), an application-specific integrated circuit (A SIC), and a field-programmable gate array (FPGA) are used. The processor 501 reads a program stored in the auxiliary storage device 503 into the main storage device 502 and executes the program. As the main storage device 502, for example, a random-access memory (RAM) is used. As the auxiliary storage device 503, for example, a magnetic disk device, a solid-state drive (SSD), or the like is used.

The computer 500 also includes a display device (display) 504 and an input device 505 through which a user performs an input operation. For example, a keyboard, a mouse, or the like is used as the input device 505. Moreover, a touch panel formed integrally with the display device 504 may be used as the input device 505. The display device 504 may be implemented by the display device 300 illustrated in FIG. 1. The configuration of the computer 500 illustrated in FIG. 5 is merely an example, and the computer 500 used in the present embodiment is not limited to the configuration example illustrated in FIG. 5. For example, a configuration including a non-volatile memory such as a flash memory or a read-only memory (ROM) as a storage device may be used.

When the control device 100 is implemented by the computer illustrated in FIG. 5, the control information acquisition unit 110 is implemented by, for example, the processor 501 and the input device 505 that read and execute the program. The function of the control unit 120 is implemented by, for example, the processor 501 that reads and executes a program. The storage unit 130 is implemented by, for example, the auxiliary storage device 503.

When the data processing device 200 is implemented by the computer illustrated in FIG. 5, the functions of the acquisition unit 210 and the processing unit 220 are implemented by, for example, the processor 501 that reads and executes a program. The storage unit 230 is implemented by, for example, the auxiliary storage device 503. The display control unit 240 is implemented by the processor 501 that reads and executes a program.

When the setting support device 400 is implemented by the computer 500 illustrated in FIG. 5, the functions of the condition reception unit 410 and the adjustment operation reception unit 450 are implemented by, for example, the processor 501 that reads and executes a program and the input device 505. The functions of the sequence information setting unit 420, the screen generation unit 430, the display control unit 440, the determination unit 460, and the control information generation unit 470 are implemented by, for example, the processor 501 that reads and executes a program. The function of the output unit 480 is implemented by, for example, the processor 501 that reads and executes a program and a communication interface (not illustrated).

### Configuration of UI Screen

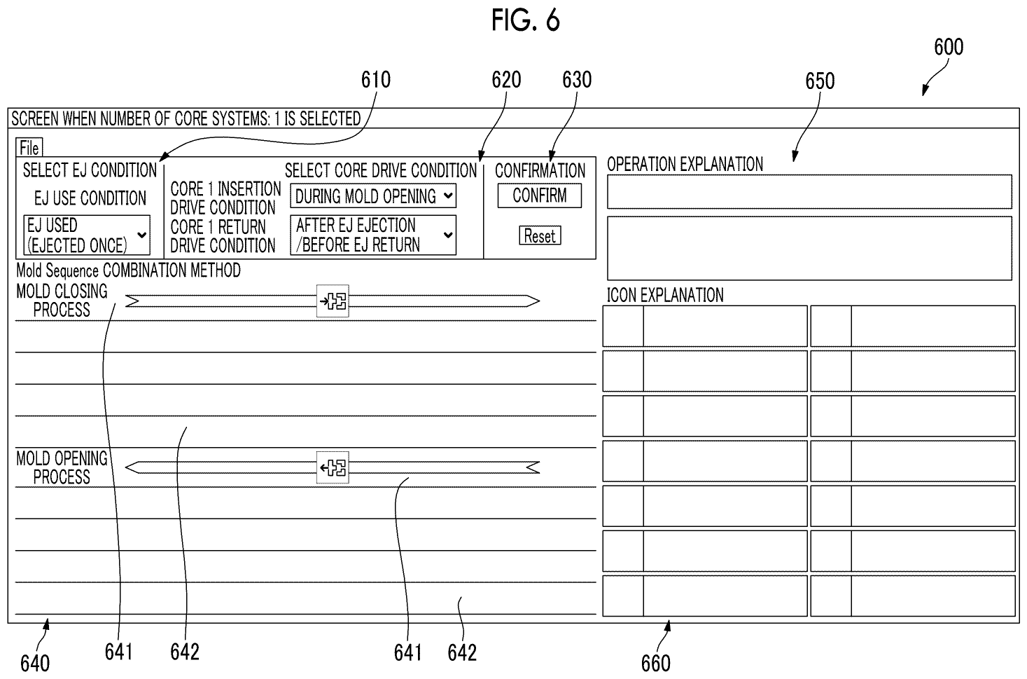

FIG. 6 is a diagram illustrating a configuration example of a UI screen generated by the screen generation unit 430 of the setting support device 400. A UI screen 600 illustrated in FIG. 6 displays a first condition selection unit 610, a second condition selection unit 620, an execution operation unit 630, a sequence image display unit 640, an operation explanation display unit 650, and an icon explanation display unit 660. The condition reception unit 410 of the setting support device 400 has been described as receiving inputs of component information and operation order information, as an example. Here, when component information of an operation component in a series of operations that are the target of sequence control is input, a UI screen 600 corresponding to the input component information is generated and displayed.

The first condition selection unit 610 and the second condition selection unit 620 are display units on which the input operation of the operation order information received by the condition reception unit 410 is performed. In the example illustrated in FIG. 6, the first condition selection unit 610 receives a selection operation for the type of operation. Then, the second condition selection unit 620 receives a selection operation of operation order information for the operations selected by the first condition selection unit 610.

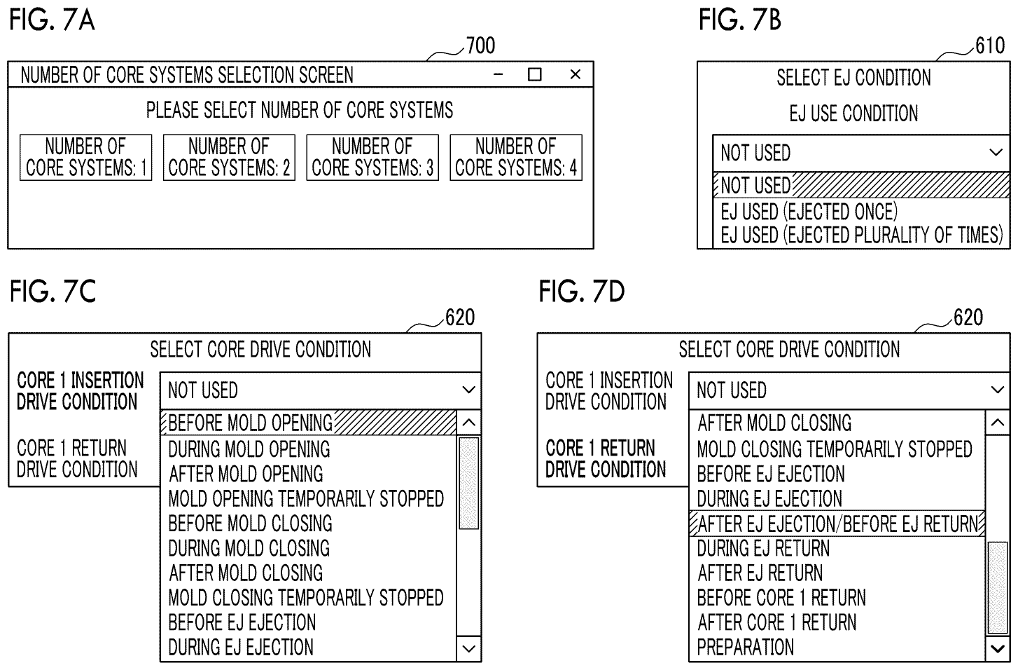

FIGS. 7A to 7D are diagrams illustrating examples of methods for inputting component information and operation order information. FIG. 7A is a diagram illustrating a method for inputting component information, FIG. 7B is a diagram illustrating a method for inputting in the first condition selection unit 610, FIG. 7C is a diagram illustrating a method for inputting one condition item in the second condition selection unit 620, and FIG. 7D is a diagram illustrating a method for inputting another condition item in the second condition selection unit 620.

When setting sequence control, the user first inputs component information using an operation screen 700 illustrated in FIG. 7A. In the example illustrated in FIG. 7A, a screen is displayed for selectively inputting the number of components (in the drawing, “number of core systems”) as component information. In the illustrated example, the number of core systems can be selected from 1 to 4.

The number of core systems means the number of core systems in a mold. In injection molding, the shape of a molding product is formed by combining a convex core with a concave cavity. Usually, the core is the movable mold and the cavity is the fixed mold. Depending on the shape of the molding product, the core may be formed by combining one or more fixed components and movable components. Here, the number of operating systems of the movable components of the core in the mold is called the number of systems. Depending on the configuration of the mold, the cavity may have movable components. In this case, the number of systems may include the number of operating systems of the movable components attached to the cavity. Also, the number of operating systems of the movable components of the core and the number of operating systems of the movable components attached to the cavity may be input as the numbers of separate systems on the operation screen 700. In the opening and closing operation of the mold, depending on the timing at which the cores of each system are operated, the molds may interfere with each other, which may result in the desired shape not being formed or the mold being damaged. Therefore, in sequence control, it is necessary to appropriately set the operation timing and operation amount of each system.

When the number of core systems is selected on the operation screen 700 as illustrated in FIG. 7A, the UI screen 600 (see FIG. 6) corresponding to the selected number of core systems is displayed. Here, an example of the UI screen 600 is illustrated when 1 is selected as the number of core systems (“number of core systems: 1” in FIG. 7A). In the following description, the core of the selected number of core systems (here, “1”) will be referred to as “core 1”. On the UI screen 600, first, operation order information is input using the first condition selection unit 610 and the second condition selection unit 620. In the first condition selection unit 610, a selection of the type of operation of the selected component is received according to the component information selected in FIG. 7A (the number of core systems in the illustrated example). Specifically, as illustrated in FIG. 7B, for example, a pull-down menu or the like is used to receive a user's selection from among selectable operations. The items selectable in the first condition selection unit 610 are specified according to, for example, the type and number of components selected on the operation screen 700. In the example illustrated in FIG. 7B, the type of operation is selected according to the use condition of an ejector (denoted as “EJ” in the drawing) for removing a molding product from a mold when the mold is opened. In the illustrated example, it is possible to select any from among an operation in a stage where the ejector is not yet used, an operation in which the ejector is ejected once, and an operation in which the ejector is ejected a plurality of times.

When a type of operation is selected in the first condition selection unit 610, the second condition selection unit 620 displays a condition item in the operation order corresponding to the selected type of operation. Then, the second condition selection unit 620 receives the selection of the condition items in the operation order. Specifically, as illustrated in FIGS. 7C and 7D, for example, a pull-down menu is used to receive a user's selection from among selectable timings. The types of conditions to be selected in the second condition selection unit 620 and the items selectable for each condition are specified according to the type of operation selected in the first condition selection unit 610, for example. In the example illustrated in FIG. 7C, “before mold opening” is selected as the execution condition for the operation of advancing core 1 to form a mold (in the drawing, “core 1 insertion drive condition”). In addition, in the example illustrated in FIG. 7D, “after EJ ejection/before EJ return” is selected as the execution condition for the operation of retracting core 1 to open the mold (in the drawing, “core 1 return drive condition”). In the examples illustrated in FIGS. 7C and 7D and FIG. 6, an example is illustrated in which information on the operation order is input in the second condition selection unit 620. In addition to this, the second condition selection unit 620 may also input additional information on the operation amount of an operation component in a target operation, a delay time in the operation, and the like.

As described above, in the present embodiment, an operation screen other than a sequence image such as the operation screen 700 in FIG. 7A and the first condition selection unit 610 and the second condition selection unit 620 in the UI screen 600 in FIG. 6 is prepared. Then, instead of the user setting the execution timing of the target operations on the sequence image from the beginning, the user is first provided with a UI to select and input the operation components and operation order to be set from pre-prepared selection items.

Referring back to FIG. 6, the execution operation unit 630 receives an input of an instruction to execute a process of generating a sequence image. In the illustrated example, a button object with the word “Confirmation” written on it (hereinafter referred to as a “confirmation button”) is displayed in the execution operation unit 630. When the user performs an operation of selecting this confirmation button, the sequence information setting unit 420 of the setting support device 400 generates sequence information based on the information input by the first condition selection unit 610 and the second condition selection unit 620. Then, the screen generation unit 430 reflects the generated sequence information in the sequence image displayed in the sequence image display unit 640 of the UI screen 600.

In addition, a button object with the word “Reset” written on it (hereinafter referred to as a “reset button”) is also displayed in the execution operation unit 630. When the user performs an operation of selecting this reset button, the information input by the first condition selection unit 610 and the second condition selection unit 620 is erased.

The sequence image generated by the screen generation unit 430 is displayed in the sequence image display unit 640. In the sequence image, for a series of operations in a process that is the target of sequence control (hereinafter referred to as a “target process”), a target image that represents a target operation that constitutes this series of operations is displayed. The sequence image illustrated in FIG. 6 includes a band region 641 representing a target process, and a disposition region 642 aligned parallel to the band region 641 and in which a target image is disposed. In the band region 641, an arrow indicating the progress direction of the target process over time and an image (icon) indicating the type of the target process are displayed. In the example illustrated in FIG. 6, an arrow pointing to the right is displayed in the band region 641 of the “mold closing process”, and an arrow pointing to the left is displayed in the band region 641 of the “mold opening process”. Although not illustrated in FIG. 6, in the disposition region 642, a target image (icon) representing a target operation is disposed for each target operation constituting a series of operations in the target process. The target image is disposed in a position on the disposition region 642 that corresponds to the time range of the target operation defined in the sequence information.

A text description explaining the target process displayed in the operation explanation display unit 650. An explanation of the target image (icon) to be disposed in the sequence image is displayed in the icon explanation display unit 660. The UI screen 600 illustrated in FIG. 6 is an example of a screen that receives an input from a user, and is not limited to the screen configuration illustrated in the drawing. When the reset button of the execution operation unit 630 is selected, the display of the sequence image display unit 640, the display of the operation explanation display unit 650, and the display of the icon explanation display unit 660 are also erased.

### Display Example of UI Screen

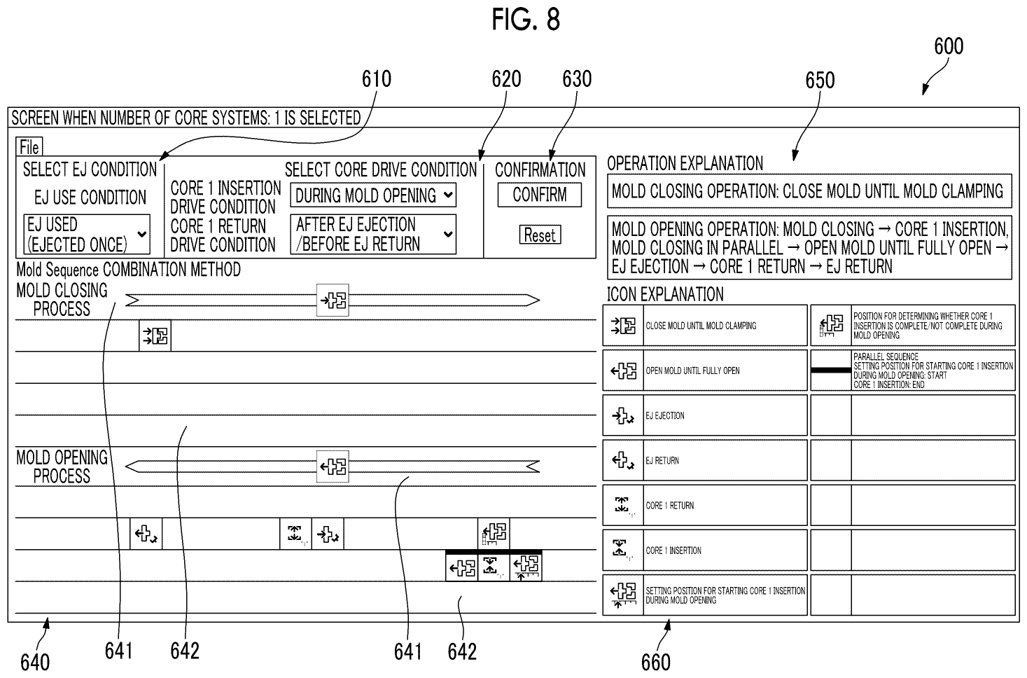

FIG. 8 is a diagram illustrating a state in which a target image is disposed on the sequence image in the sequence image display unit 640 on the UI screen 600 illustrated in FIG. 6. In the state illustrated in FIG. 6, in the first condition selection unit 610 of the UI screen 600, “EJ used (ejected once)” is selected as the EJ use condition. In addition, in the second condition selection unit 620, “during mold opening” is selected as the core 1 insertion drive condition, and “after EJ ejection/before EJ return” is selected as the core 1 return drive condition. In this state, when the confirmation button of the execution operation unit 630 is selected, the displays of the sequence image display unit 640, the operation explanation display unit 650, and the icon explanation display unit 660 are updated as illustrated in FIG. 8.

Referring to the operation explanation display unit 650 in FIG. 8, in the mold closing operation, it is described as “mold closing operation: close mold until mold clamping”, and it is understood that the operation of closing the mold is performed until the mold is clamped. Furthermore, in the mold opening operation, it is described as “mold opening operation: mold closing→core 1 insertion, mold closing in parallel→open mold until fully open→EJ ejection→core 1 return→EJ return”, and it is understood that in mold closing, the operation of advancing core 1 and mold closing are performed in parallel, then the mold is opened until fully open, then the ejector is ejected, then core 1 is retracted, and then the ejector is returned.

In the icon explanation display unit 660 in FIG. 8, explanations of nine target images (icons) are displayed. The target images (icons), from top to bottom of the left column, are “close mold until mold clamping”, “open mold until fully open”, “EJ ejection”, “EJ return”, “core 1 return”, “core 1 insertion”, and “setting position for starting core 1 insertion during mold opening”. Also, from the top of the right column, they are “position for determining whether core 1 insertion is complete/not complete during mold opening” and “parallel sequence”.

Referring to the sequence image display unit 640 of FIG. 8, target images (icons) are disposed in a disposition region 642 (upper row) corresponding to the band region 641 of the mold closing process and a disposition region 642 (lower row) corresponding to the band region 641 of the mold opening process. The disposition of target images (icons) in each process corresponds to the content of the operation displayed in the operation explanation display unit 650.

As described above, the UI screen 600 provided by the present embodiment has a first condition selection unit 610 and a second condition selection unit 620 provided as means for inputting information for specifying the execution timing of a target operation, in addition to the input means using a sequence image. This allows the user to set execution conditions for each target operation in the target process by specifying conditions, in addition to the intuitive operation of disposing a target image (icon) on the sequence image. In addition, when the input content of the first condition selection unit 610 and the second condition selection unit 620 is changed, the changed content is reflected in the display of the sequence image display unit 640, the display of the operation explanation display unit 650, and the display of the icon explanation display unit 660. Furthermore, in the present embodiment, in response to inputs from the first condition selection unit 610 and the second condition selection unit 620, an execution order of the target operations that does not violate the logic of the sequence is specified. Then, a sequence image reflecting the execution order of the specified target operations is displayed on the sequence image display unit 640. Therefore, the user only needs to make desired settings based on the automatically generated sequence images, reducing the time and effort required for setting. The settings shown in the sequence image are sent to the control device 100. The control device 100 may automatically update the control information 131 held by the storage unit 130 based on this setting.

Furthermore, in the sequence image display unit 640, the target images (icons) disposed in the sequence images can be moved by manual operation. Specifically, for example, a desired target image (icon) can be selected and dragged using a pointing device such as a mouse to move the target image. When the position of a target image (icon) in the sequence image changes, the sequence information setting unit 420 changes the execution timing of the target operation corresponding to the target image (icon) whose position has been changed in accordance with this change in position. The user can adjust the execution timing of a target operation in a target process by moving a target image (icon) disposed in the sequence image on the UI screen 600. When the target image of the sequence image is moved, the input contents of the first condition selection unit 610 and the second condition selection unit 620 and the display contents of the operation explanation display unit 650 and the icon explanation display unit 660 are changed corresponding to the change content of the sequence image. In addition, in a case in which an operation of moving a target image in a sequence image is performed, when the content of the sequence image after the operation differs from the input contents of the first condition selection unit 610 and the second condition selection unit 620, a message to that effect may be displayed.

Here, the determination unit 460 determines whether or not the logic of the sequence is established at the execution timing of the target operation after the change. When the logic of the sequence is not established, the sequence information setting unit 420 and the screen generation unit 430 reject the movement of such a target image (icon). Specifically, for example, it is conceivable that a message notifying the user that movement to the designated position is not possible may be displayed, or an operation of moving the target image (icon) may not be received. Also, after receiving the movement of a target image (icon) in a sequence image, a message notifying the user that the target process cannot be executed with such settings may be displayed. Furthermore, even when the logic of the sequence is established, a message notifying the user that the content differs from that set by the sequence information setting unit 420 may be displayed.

### Determination of Sequence Images

In the above example, the first condition selection unit 610 and the second condition selection unit 620 are used to input information for specifying the execution timing of the target operation. Then, on the sequence image generated based on the input information, adjustments made by the user's manual operation to the execution timing of the target operation are received. In response to this, the user may manually dispose a target image (icon) on the sequence image in the sequence image display unit 640 to input information for specifying the execution timing of the target operation.

In this case, the screen generation unit 430 updates the sequence image to reflect the user's operation, and sends the position information of the target image (icon) in the updated sequence image to the sequence information setting unit 420. The sequence information setting unit 420 specifies the execution timing of the target operation corresponding to the target image (icon) in the target process based on the acquired position information. Then, the determination unit 460 determines whether or not the logic of the sequence is established based on the execution timing of the target operation specified by the sequence information setting unit 420. When the determination unit 460 determines that the logic of the sequence is established, the sequence information setting unit 420 sends the sequence information to the control information generation unit 470. Then, the control information generation unit 470 generates control information based on the acquired sequence information and transmits the control information to the control device 100.

On the other hand, when the determination unit 460 determines that the logic of the sequence is not established at the execution timing of the target operation set by the sequence information setting unit 420, the control information generation unit 470 does not generate control information. Therefore, control information for implementing the execution timing of such a target operation is not generated. Then, the control device 100 cannot control the injection unit 20 and the mold clamping unit 30 based on such control information, and cannot execute the target process of such control content. Then, the screen generation unit 430 displays a message notifying the user that the target process cannot be executed with the settings input by operating the sequence image.

Although the embodiment of the present invention has been described above, the technical scope of the present invention is not limited to the above-described embodiment. For example, in the above embodiment, the first condition selection unit 610, the second condition selection unit 620, the execution operation unit 630, the sequence image display unit 640, the operation explanation display unit 650, and the icon explanation display unit 660 are displayed on a single screen in the UI screen 600, but these may be created as separate screens and displayed by switching between them.

In the above embodiment, an example has been shown in which an input is performed by selecting an item displayed in a menu in the first condition selection unit 610 and the second condition selection unit 620. However, the method for inputting the conditions is not limited thereto. For example, a chat system may be used to input information in an interactive format.

The setting support device 400 in the above embodiment may be implemented by a computer built into the injection molding machine 10, or may be implemented by a computer separate from the injection molding machine 10. In the latter case, the setting support device 400 transmits control information to the control device 100 of the injection molding machine 10 via a network or the like.

In addition, in the above embodiment, the setting support device 400 is applied to the operation of the mold of the injection molding machine 10, but the present embodiment can be widely applied to machines that perform a series of operations under sequence control. In the injection molding machine 10, the present invention can be applied to control the operation of the screw and valve gate, for example, in addition to the operation of the mold. It may also be applied to control the operation of safety doors and plasticizing movements. Furthermore, the present invention can also be applied to the control of the operation of devices other than injection molding devices, such as presses and robots.

It should be understood that the invention is not limited to the above-described embodiment, but may be modified into various forms on the basis of the spirit of the invention. Additionally, the modifications are included in the scope of the invention.

What is claimed is:

1. A setting support system comprising:
a first reception unit that receives, regarding a setting of sequence control that controls a series of operations in a machine, inputs of component information indicating an operation component that is a component that operates in the series of operations and operation order information indicating an operation order of the operation component;
a processing unit that specifies a time range in which each of a plurality of target operations that constitute the series of operations is executable based on the component information and the operation order information and a logic of a sequence for the series of operations; and
a display control unit that displays, on a display device, a sequence image, which is an image in which a plurality of target images corresponding to each of the plurality of target operations are disposed in an execution order, based on the time range specified for each of the plurality of target operations.

2. The setting support system according to claim 1, further comprising:
a second reception unit that receives an operation of moving each of the plurality of target images displayed by the display control unit.

3. The setting support system according to claim 1, further comprising:
a control information generation unit that generates control information for setting the machine such that each of the plurality of target operations corresponding to a target image is executed by the machine at a timing corresponding to a disposition of the plurality of target images in the sequence image.

4. The setting support system according to claim 1,
wherein the first reception unit further receives an input of an execution condition for an operation of the operation component indicated by the component information, and
the processing unit determines whether or not the operation of the operation component according to the execution condition is executable based on the logic of the sequence.

5. The setting support system according to claim 4,
wherein the first reception unit presents the execution condition and one or more additional execution conditions that are designatable, and receives a selection of one or more of the execution conditions that are presented.

6. The setting support system according to claim 5,
wherein a user interface screen generated by the display control unit displays a first condition selection unit and a second condition selection unit that are display units on which an input operation of the operation order information received by the first reception unit is performed.

7. The setting support system according to claim 6,
wherein the first condition selection unit receives a selection operation for a type of the operation, and
the second condition selection unit receives a selection operation of the operation order information for the operation selected by the first condition selection unit.

8. The setting support system according to claim 2, further comprising:
a determination unit that determines whether or not, in a disposition of the target image based on the operation received by the second reception unit, the logic of the sequence is established.

9. The setting support system according to claim 8,
wherein a change in the disposition of the target image on the sequence image means that an execution timing of the target operation corresponding to the target image has been changed, and
the determination unit determines whether or not the change in the execution timing is within a time range in which the target operation that is permitted in the logic of the sequence is executable.

10. The setting support system according to claim 2,
wherein the operation of moving each of the target images received by the second reception unit is limited to movement within a range corresponding to the time range for each of the target operations corresponding to each target image.

11. A setting support system comprising:
a display control unit that displays, on a display device, a sequence image in which a plurality of target images corresponding to a plurality of target operations that constitute a series of operations in a machine are arranged and displayed in an execution order of each of the plurality of target operations;
a reception unit that receives an operation of disposing the plurality of target images in the sequence image to set the series of operations; and
a determination unit that determines whether or not, in a disposition of the plurality of target images based on the operation that is received, a logic of a sequence for the series of operations is established for the plurality of target operations corresponding to the plurality of target images.

12. The setting support system according to claim 11, further comprising:
a control information generation unit that generates control information for setting the machine such that each of the target operations corresponding to the target images is executed by the machine at a timing corresponding to the disposition of the target images in the sequence image in which the determination unit has determined that the logic of the sequence is established.

13. An injection molding machine comprising:
the setting support system according to claim 1;
an injection unit;
a mold clamping unit; and
a control device that controls an injection molding operation of the injection unit and the mold clamping unit based on a setting of the target operation of the setting support system corresponding to a disposition of the target image in the sequence image.

14. A non-transitory computer readable medium storing a program, the program when executed by a computer, causing the computer to:
receive, regarding a setting of sequence control that controls a series of operations in a machine, inputs of component information indicating an operation component that is a component that operates in the series of operations and operation order information indicating an operation order of the operation component;
specify a time range in which each of a plurality of target operations that constitute the series of operations is executable based on the component information and the operation order information and a logic of a sequence for the series of operations;
display, on a display device, a sequence image, which is an image in which a plurality of target images corresponding to each of the plurality of target operations are disposed in an execution order, based on the time range specified for each of the plurality of target operations; and
receive an operation of moving each of the target images in the sequence image within the time range for each of the target operations corresponding to each target image.

15. A non-transitory computer readable medium storing a program, the program when executed by a computer, causing the computer to:
display, on a display device, a sequence image in which a plurality of target images corresponding to a plurality of target operations that constitute a series of operations in a machine are arranged and displayed in an execution order of each of the plurality of target operations;
receive an operation of disposing the plurality of target images in the sequence image to set the series of operations; and
determine whether or not, in a disposition of the plurality of target images based on the operation that is received, a logic of a sequence for the series of operations is established for the plurality of target operations corresponding to the plurality of target images.
